(19) United States
(12) Patent Application Publication
(10) Pub. No.: US 2013/0074957 A1
(43) Pub. Date: Mar. 28, 2013

(54) PRESSURE VALVE FOR ENERGY STORAGE DEVICE AND ENERGY STORAGE DEVICE INCLUDING THE SAME

(71) Applicants: Yeong Su CHO, Gyeonggi-do (KR); Sung Yeol Park, Gyeonggi-do (KR); Jung Eun Noh, Gyeonggi-do (KR); Bae Kyun Kim, Gyeonggi-do (KR); Kang Heon Hur, Gyeonggi-do (KR)

(72) Inventors: Yeong Su CHO, Gyeonggi-do (KR); Sung Yeol Park, Gyeonggi-do (KR); Jung Eun Noh, Gyeonggi-do (KR); Bae Kyun Kim, Gyeonggi-do (KR); Kang Heon Hur, Gyeonggi-do (KR)

(73) Assignee: SAMSUNG ELECTRO-MECHANICS CO., LTD.

(21) Appl. No.: 13/620,989

(22) Filed: Sep. 15, 2012

(30) Foreign Application Priority Data
Sep. 27, 2011 (KR) 10-2011-0097812

(51) Int. Cl. F16K 15/00

(52) U.S. Cl. 137/528

(57) ABSTRACT

Disclosed herein is a pressure valve for an energy storage device. The energy storage device according to an exemplary embodiment of the present invention includes: a valve body provided with a vent guide for communicating a gas vent of the energy storage device with the outside; and an elastic body interposed between the valve body and the gas vent to elastically support the valve body to an inner side of the gas vent to move the valve body to an outer side of the gas vent when a gas pressure in the gas vent rises, thereby communicating the vent guide with the outside and recover the valve body when the gas pressure in the gas vent falls, thereby blocking the vent guide from the outside.

### CROSS REFERENCE(S) TO RELATED APPLICATIONS

This application claims the benefit under 35 U.S.C. Section 119 of Korean Patent Application Serial No. 10-2011-0097812, entitled “Pressure Valve For Energy Storage Device And Energy Storage Device Including The Same” filed on Sep. 27, 2011, which is hereby incorporated by reference in its entirety into this application.

### BACKGROUND OF THE INVENTION

1. Technical Field

The present invention relates to a pressure valve for an energy storage device and an energy storage device including the same, and more particularly, to a pressure valve for an energy storage device and an energy storage device including the same capable of preventing and minimizing a discharge of an electrolytic solution in the energy storage device to the outside at the time of discharging gases while minimizing a volume in the pressure valve with a simple structure and smoothly discharging the gases generated from the energy storage device.

2. Description of the Related Art

Recently, with the technology development of electric and electronic communication fields, various types of mobile electronic products have been released and applications of an energy storage device such as a secondary battery, or the like, have been expanded.

In addition, as the focus on environmental problems and resource problems has been increased, the competition for developing a technology relating to a car using environmental friendly energy or environmental friendly production such as solar power generation, or the like, is intensifying.

A representative example of an electric energy storage device that has been the most widely used up to the present may include a secondary battery that may be used for a long period for time through charging and discharging. The secondary battery may maintain an output at predetermined voltage for a relatively long period of time and may be manufactured to have a small and light structure and thus, has been widely used as a power storage device for small mobile devices.

Meanwhile, the secondary battery may have disadvantages in that time consumed to perform charging and discharging is relatively long, output voltage is as low as about 3V, a lifespan is short, a risk of explosion is large, or the like, such that the secondary battery has a limitation in applications.

As the energy storage device capable of supplementing the disadvantages of the above-mentioned secondary battery, an interest in a supercapacitor performing a charging and discharging operation by an electrochemical mechanism has been increased.

There are various types of supercapacitors, such as an electric double layer capacitor (EDLC), a hybrid capacitor, a pseudo-capacitor, or the like. The supercapacitor can implement instantaneous charging, more excellent output characteristics than the secondary battery, and a longer lifespan than the secondary battery.

Considering the above-mentioned advantages, a study for the supercapacitor to be used as regenerative braking of a car has been maintained.

Meanwhile, the energy storage devices such as the secondary battery, the supercapacitor, or the like, has an electrolytic solution (or electrolyte) between electrodes and performs the charging and discharging process by the electrochemical mechanism. In this case, various gases may be generated. Therefore, when these gases are not appropriately discharged, a case of the energy storage device is ruptured, such that the energy storage device may not be used any more or in extreme cases, may be exploded.

The supercapacitor does not completely solve problems such as energy density, resistance, or the like, such that it is difficult to smoothly commercialize the supercapacitor. However, the supercapacitor is expected to be commercialized in the near future. Therefore, there is a need to solve problems of degradation in reliability and reduction in lifespan due to the gas generation as described above.

FIG. 1 shows a configuration of a valve disclosed in KR Patent Application No. 2003-47556 proposed to solve the above-mentioned problems.

Referring to FIG. 1, in the case of the valve disclosed in the above Patent Document, a method for discharging gases by rupturing a metal thin film 1 when a pressure is increased due to the gases generated from the energy storage device is used. When the method is used, maintenance costs may be increased and maintenance may be complicated since the metal thin film needs to be replaced each time the metal thin film 1 is ruptured.

In addition, the electrolytic solution in the energy storage device may be discharged to the outside when the metal thin film 1 is ruptured.

### SUMMARY OF THE INVENTION

An object of the present invention is to provide a pressure valve for an energy storage device and an energy storage device including the same capable of being semi-permanently used while maintaining an internal pressure of the energy storage device into a predetermined range.

Another object of the present invention is to provide a pressure valve for an energy storage device and an energy storage device including the same capable of preventing and minimizing a discharge of an electrolytic solution in the energy storage device to the outside at the time of discharging gases while minimizing a volume of the pressure valve with a simple structure and smoothly discharging the gases generated from the energy storage device.

According to an exemplary embodiment of the present invention, there is provided a pressure valve for an energy storage device, including: a valve body provided with a vent guide for communicating a gas vent of the energy storage device with the outside; and an elastic body interposed between the valve body and the gas vent to elastically support the valve body to an inner side of the gas vent to move the valve body to an outer side of the gas vent when a gas pressure in the gas vent rises, thereby communicating the vent guide with the outside and recover the valve body when the gas pressure in the gas vent falls, thereby blocking the vent guide from the outside.

The valve body may be elastically moved reciprocally in and out the gas vent in a state in which a bottom portion of the valve body is inserted into the gas vent.

The pressure valve for an energy storage device may further include a sealing member disposed at a top edge portion of an inner side of the gas vent to maintain airtight of the gas vent when the valve body is reciprocally moved within the gas vent.

The elastic body may be formed of a plurality of leaf springs that are protruded from an outer side of the valve body, the protruded end thereof being fixed to a top surface of the energy storage device.

The plurality of leaf springs may be disposed on the valve body in a radiation form.

The protruded ends of each leaf spring may be fixed to a top surface of the energy storage device by a welding method or a fastening method using a fastening member.

The pressure valve for an energy storage device may further include a mesh member disposed in the vent guide to uniformly control a flow of gases discharged to the outside through the vent guide.

The pressure valve for an energy storage device may further include a porous absorbing member disposed in the vent guide and formed with a plurality of fine holes to discharge the gases to the outside and absorb an electrolyte included in the discharged gases.

The vent guide may be disposed at a bottom edge portion of the outer side of the valve body, including at least one elongated guide groove along a moving direction of the valve body.

According to another exemplary embodiment of the present invention, there is provided an energy storage device including the pressure valve for an energy storage device as described above.

### BRIEF DESCRIPTION OF THE DRAWINGS

FIG. 1 is a cross-sectional view schematically showing a valve for an energy storage device according to the related art.

FIG. 2 is a cross-sectional view schematically showing a pressure valve for an energy storage device according to a first exemplary embodiment of the present invention.

FIG. 3 is a cross-sectional view schematically showing a state in which a vent guide communicates with the outside in FIG. 2.

FIG. 4 is a plan view of FIG. 2.

FIG. 5 is a perspective view schematically showing only a valve body of FIG. 2.

FIG. 6 is a cross-sectional view schematically showing a pressure valve for an energy storage device according to a second exemplary embodiment of the present invention.

FIG. 7 is a cross-sectional view schematically showing a pressure valve for an energy storage device according to a third exemplary embodiment of the present invention.

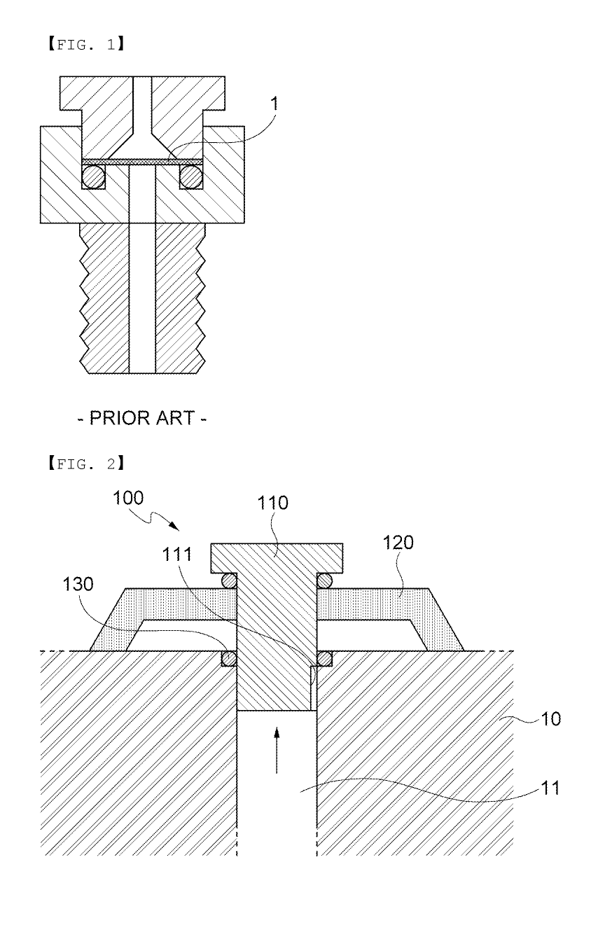

### DESCRIPTION OF THE PREFERRED EMBODIMENTS

Various advantages and features of the present invention and methods accomplishing thereof will become apparent from the following description of embodiments with reference to the accompanying drawings. However, the present invention may be modified in many different forms and it should not be limited to the embodiments set forth herein. Rather, these embodiments may be provided so that this disclosure will be thorough and complete, and will fully convey the scope of the invention to those skilled in the art. Like reference numerals throughout the description denote like elements.

Terms used in the present specification are for explaining the embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Further, the exemplary embodiments described in the specification will be described with reference to cross-sectional views and/or plan views that are ideal exemplification figures. In drawings, the thickness of layers and regions is exaggerated for efficient description of technical contents. Therefore, exemplified forms may be changed by manufacturing technologies and/or tolerance. Therefore, the exemplary embodiments of the present invention are not limited to specific forms but may include the change in forms generated according to the manufacturing processes. For example, an etching region vertically shown may be rounded or may have a predetermined curvature. Therefore, the regions shown in the drawings have schematic attributes and the shapes shown in the drawings show specific shapes of device regions by way of example only but are not limited to the scope of the present.

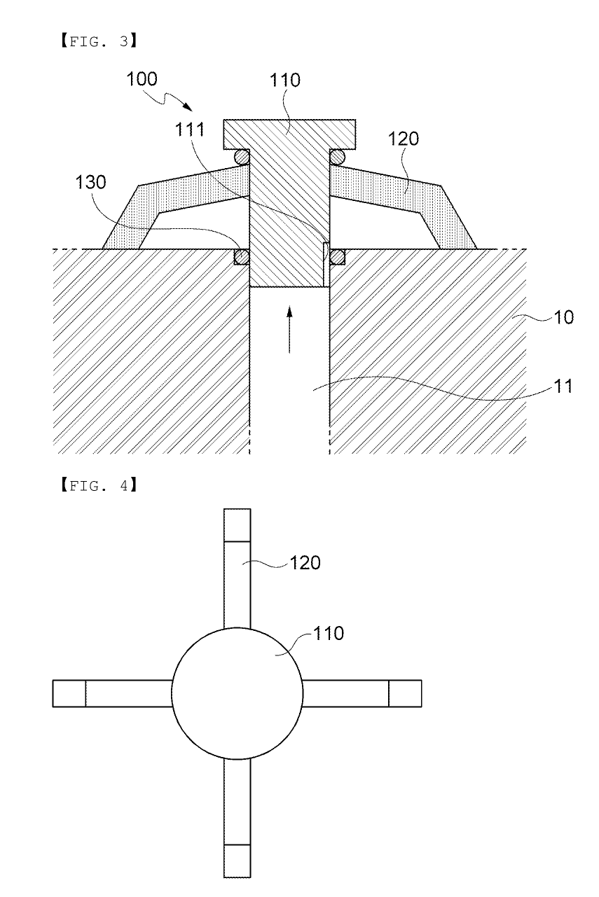

First, the pressure valve for an energy storage device according to a first exemplary embodiment of the present invention will be described with reference to FIGS. 2 to 5.

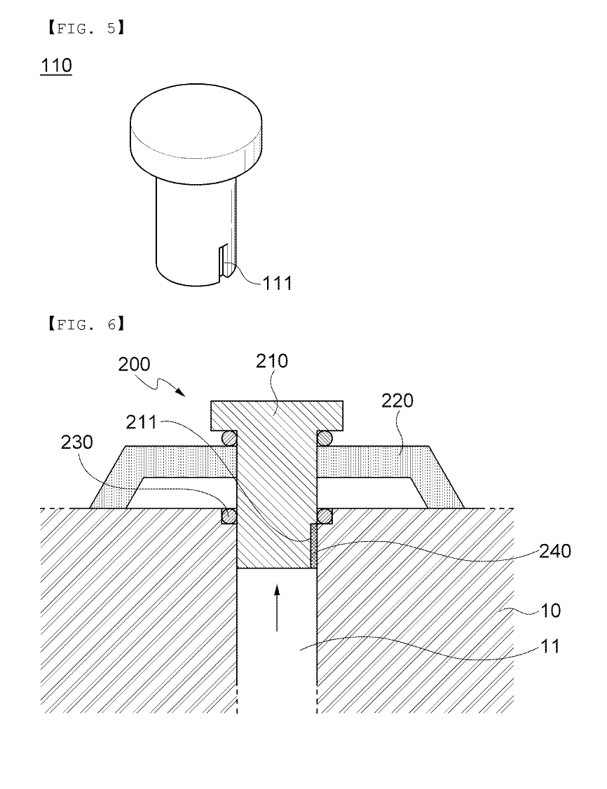

FIG. 2 is a cross-sectional view schematically showing a pressure valve for an energy storage device according to a first exemplary embodiment of the present invention, FIG. 3 is a cross-sectional view schematically showing a state in which a vent guide communicates with the outside in FIG. 2, FIG. 4 is a plan view of FIG. 2, and FIG. 5 is a perspective view schematically showing only a valve body of FIG. 2.

Referring to FIG. 2 to 5, a pressure valve 100 for an energy storage device according to an exemplary embodiment of the present invention may be largely configured to include a valve body 110 and an elastic body 120.

In this configuration, the valve body 110 may be provided with a vent guide 111 for communicating a gas vent 11 of the energy storage device 10 with the outside.

Further, the elastic body 120 is interposed between the valve body 110 and the gas vent 11 to elastically support the valve body 110 to an inner side of the gas vent 11 to move the valve body 110 to the outer side of the gas vent 11 when a gas pressure in the gas vent 11 rises, thereby communicating the vent guide 111 with the outside and recovers the valve body 110 when the gas pressure in the gas vent 11 falls, thereby blocking the vent guide 111 from the outside.

In this case, the valve body 110 may be formed in an approximate bolt shape and may be elastically moved reciprocally in and out the gas vent 11 in a state in which a bottom portion of the valve body is inserted into the gas vent 11.

Further, the elastic body 120 may be formed of a plurality of leaf springs that are integrally protruded from an outer side of the valve body 110, wherein the protruded end thereof is fixed to a top surface of the energy storage device 10.

In this case, when the elastic body 120 is formed of a plurality of leaf spring forms, the plurality of leaf springs may be disposed on the valve body 110 in a radiation form.

In addition, the number of leaf springs configuring the elastic body 120 may preferably be disposed at least three or more along a circumferential direction of the outer side of the valve body 110 so as to stably support elastically the reciprocal movement of the valve body 110, but is not limited thereto.

Further, the elastic body 120 may be integrally formed with the valve body 110 but may be separately manufactured so as to be fastened to the valve body 110 by a fastening member such as welding, a screw, or the like.

In addition, the protruded end of the elastic body 120, that is, the protruded ends of each leaf spring may be fixed to the top surface of the energy storage device 10 by a welding method or a fastening method using a fastening member such as a screw.

Meanwhile, the pressure valve 100 for an energy storage device according to the embodiment of the present invention may be configured to further include a sealing member 130 disposed at a top edge portion of the inner side of the gas vent 11 to maintain airtight of the gas vent 11 when the valve body 110 is reciprocally moved within the gas vent 11.

In this configuration, a strip shape of a fixing groove may be disposed at the top edge portion of the inner side of the gas vent 11 so as to provide the sealing member 130, wherein the sealing member 130 may be fixed in the fixing groove by a press-fit method or a bonding method, or the like.

In addition, the sealing member 130 may be made of a flexible material such as rubber.

Meanwhile, the vent guide 111 may be disposed at a bottom edge portion of the outer side of the valve body 110, including at least one elongated guide groove along a moving direction of the valve body 110.

That is, the vent guide 111 discharges gases within the gas vent 11 by communicating the gas vent 11 with the outside, if the valve body 110 moves upwardly by a pressurization force generated by the gas pressure when the gas pressure within the gas vent 11 rises to a predetermined pressure or more.

In addition, when the gas pressure within the gas vent 11 falls to a predetermined pressure or less due to the gas discharge, the valve body 110 moves downwardly by an elastic restoring force of the elastic body 120 by releasing the pressurization force of gases applied to the valve body 110, such that the vent guide 111 is drawn in the gas vent 11 to block the gas discharge within the gas vent 11.

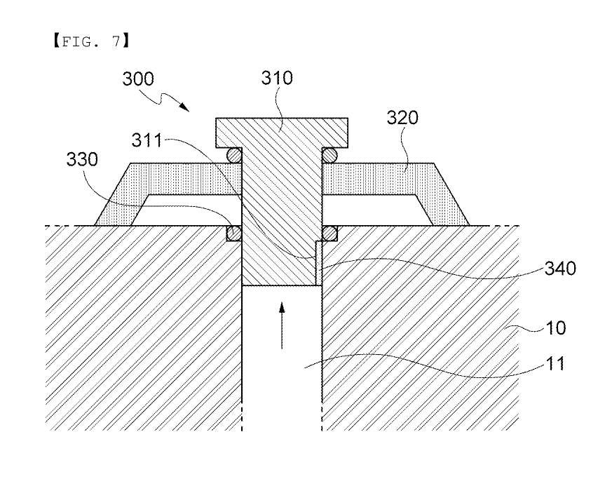

Next, the pressure valve for an energy storage device according to a second exemplary embodiment of the present invention will be described with reference to FIG. 6.

FIG. 6 is a cross-sectional view schematically showing a pressure valve for an energy storage device according to a second exemplary embodiment of the present invention.

As shown in FIG. 6, a pressure valve 200 for an energy storage device according to an exemplary embodiment of the present invention may be configured to include a valve body 210 formed with a bent guide 211 and an elastic body 220 elastically supporting a reciprocal movement of the valve body 210 in a state in which the valve body 210 is inserted into the gas vent 11 of the energy storage device 10, similar to the pressure valve for an energy storage device according to the first exemplary embodiment as described above.

However, unlike the above-mentioned first exemplary embodiment of the present invention, the pressure valve 200 for an energy storage device according to the exemplary embodiment of the present invention may be configured to further include a mesh member 240 disposed in the vent guide 211.

That is, the pressure valve 200 for an energy storage device according to the exemplary embodiment of the present invention includes the mesh member 240 disposed in the vent guide 211 to uniformly control a flow of gases discharged to the outside through the vent guide 211, such that the pressure valve 200 for an energy storage device uniformly controls the flow of gas passing through the mesh member 240 to distribute the gas flowing pressure, thereby previously preventing the valve from being suddenly and forcibly operated.

Meanwhile, the pressure valve 200 for an energy storage device according to the exemplary embodiment of the present invention may also be configured to further include a sealing member 230 disposed in the gas vent 11.

Next, the pressure valve for an energy storage device according to a third exemplary embodiment of the present invention will be described with reference to FIG. 7.

FIG. 7 is a cross-sectional view schematically showing a pressure valve for an energy storage device according to a third exemplary embodiment of the present invention.

Similar to the pressure value for the energy storage device according to the first embodiment as described above, as shown in FIG. 7, a pressure valve 300 for an energy storage device according to an exemplary embodiment of the present invention may be configured to include a valve body 310 formed with a bent guide 311 and an elastic body 320 elastically supporting a reciprocal movement of the valve body 310 in a state in which the valve body 310 is inserted into the gas vent 11 of the energy storage device 10

However, unlike the above-mentioned first exemplary embodiment of the present invention, the pressure valve 300 for an energy storage device according to the exemplary embodiment of the present invention may be configured to further include a porous absorbing member 340 disposed in the vent guide 311.

In this configuration, the porous absorbing member 340 may be made of a porous material in which a plurality of fine holes formed along a flowing direction of gases discharged through the vent guide 311 are formed and may also be formed of materials having high absorbency so as to absorb an electrolyte included in the gases discharged through the vent guide 311, for example, any one of ethylene vinyl acetate (EVA), poly vinyl chloride (PVC), and polyurethane.

Therefore, the pressure valve 300 for an energy storage device according to the exemplary embodiment of the present invention may preventing and minimize the discharge of the electrolytic solution to the outside at the time of discharges the gases by discharging the gases to the outside through the fine holes formed in the porous absorbing member 340 disposed in the vent guide 311 and absorbing the electrolytic solution included in the gases disposed to the outside when the vent guide 311 communicates with the outside by increasing the gas pressure within the gas vent 11 to a predetermined pressure or more.

Meanwhile, the pressure valve 300 for an energy storage device according to the exemplary embodiment of the present invention may also be configured to further include a sealing member 330 disposed in the gas vent 11.

As set forth above, the pressure valve for an energy storage device and the energy storage device including the same according to the exemplary embodiments of the present invention can appropriately solve the increase in internal pressure due to the gases generated from the energy storage device while minimizing the volume of the pressure valve with the simple structrue so as to improve the reliability of the energy storage device and can semi-permanently use the pressure valve to save the maintenance costs and improving the maintenance capability.

In addition, the pressure valve for an energy storage device and the energy storage device including the same according to the exemplary embodiments of the present invention can prevent and minimize the discharge of the electrolytic solution in the energy storage device to the outside at the time of discharging the gases while smoothly discharging the gases generated from the energy storage device.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A pressure valve for an energy storage device, comprising:
a valve body provided with a vent guide for communicating a gas vent of the energy storage device with the outside; and
an elastic body interposed between the valve body and the gas vent to elastically support the valve body toward an inner side of the gas vent to move the valve body to an outer side of the gas vent when a gas pressure in the gas vent rises, thereby communicating the vent guide with the outside and recover the valve body when the gas pressure in the gas vent falls, thereby blocking the vent guide from the outside.

2. The pressure valve for an energy storage device according to claim 1, wherein the valve body is elastically moved reciprocally in and out the gas vent in a state in which a bottom portion of the valve body is inserted into the gas vent.

3. The pressure valve for an energy storage device according to claim 2, further comprising a sealing member disposed at a top edge portion of an inner side of the gas vent to maintain airtight of the gas vent when the valve body is reciprocally moved within the gas vent.

4. The pressure valve for an energy storage device according to claim 1, wherein the elastic body is formed of a plurality of leaf springs that are protruded from an outer side of the valve body, the protruded end thereof being fixed to a top surface of the energy storage device.

5. The pressure valve for an energy storage device according to claim 4, wherein the plurality of leaf springs are disposed on the valve body in a radiation form.

6. The pressure valve for an energy storage device according to claim 4, wherein the protruded ends of each leaf spring are fixed to a top surface of the energy storage device by a welding method or a fastening method using a fastening member.

7. The pressure valve for an energy storage device according to claim 1, further comprising a mesh member disposed in the vent guide to uniformly control a flow of gases discharged to the outside through the vent guide.

8. The pressure valve for an energy storage device according to claim 1, wherein a porous absorbing member disposed in the vent guide and formed with a plurality of fine holes to discharge the gases to the outside and absorb an electrolyte included in the discharged gases.

9. The pressure valve for an energy storage device according to claim 1, wherein the vent guide is disposed at a bottom edge portion of the outer side of the valve body, including at least one elongated guide groove along a moving direction of the valve body.

10. An energy storage device including the pressure valve for an energy storage device according to any one of claims 1 to 9.
